(19) United States
(12) Patent Application Publication
(10) Pub. No.: US 2025/0348449 A1
(43) Pub. Date: Nov. 13, 2025

(54) COALESCING OF DATA AT A STORAGE DEVICE CONTROLLER

(71) Applicant: Microchip Technology Incorporated, Chandler, AZ (US)

(72) Inventors: Pankaj CHAURASIA, San Ramon, CA (US); Mohammadreza ROZEHREZVANI, North Vancouver (CA); Deepali JOSHI, Coquitlam (CA); James Adam LEIGHTON, Orangevale, CA (US); Tim James SYMONS, Anmore (CA)

(21) Appl. No.: 19/201,418

(22) Filed: May 7, 2025

Related U.S. Application Data
(60) Provisional application No. 63/644,504, filed on May 8, 2024.

(51) Int. Cl. G06F 13/16

(52) U.S. Cl. CPC G06F 13/1689; G06F 13/1626; G06F 13/1673

(57) ABSTRACT

In some implementations, a storage device may receive a set of access requests, the set of access request comprising a subset of the set of access requests that are associated with a data stream, the subset being associated with an amount of permissible delay for processing. The storage device may delay processing the subset of access requests based at least in part on the permissible delay and association with a data stream. The storage device may process the subset of access requests sequentially based at least in part on the delay.

### CROSS-REFERENCE TO RELATED APPLICATION

This Patent Application claims priority to Provisional Patent Application No. 63/644,504, filed on May 8, 2024, and entitled “COALESCING OF DATA AT A STORAGE DEVICE CONTROLLER.” The disclosure of the prior Application is considered part of and is incorporated by reference into this Patent Application.

### FIELD

The present disclosure generally relates to operations performed at a storage device. A controller of the storage device may receive multiple streams of access requests. The controller may perform the access requests in an order that is based at least in part on arrival times of the access requests.

### BACKGROUND

A non-volatile memory device may include a storage device (e.g., a non-volatile memory device) that may store and retain data without external power supply. One example of a storage device is a not-AND (NAND) flash memory device.

A virtual block (V B) is a collection of blocks (e.g., NAND blocks) across all logical unit numbers (LUNs). The VB includes multiple virtual pages. A virtual page is a collection of pages (e.g., NAND pages) across all LUNs in a VB. Similarly, a virtual word line is a collection of word lines (e.g., NAND word lines) across all LUNs in a VB.

When a storage device receives access requests (e.g., to read or write data at a physical location of a storage medium of the storage device, such as a page), the controller may access a first page of a storage medium associated with a first stream to read or write data on the first page, then access a second page associated with a second stream to read or write data on the second page, then access a third page associated with the third page. The controller may again access the first page to read or write additional data on the first page based at least in part on the additional data being associated with the data that was previously read or written to the first page. In this way, the controller accesses pages of the storage medium based at least in part on timing of receipt of access requests at the controller.

### SUMMARY

In some implementations, a method performed by a storage device includes receiving a set of access requests with the set of access requests comprising a subset of the set of access requests that are associated with a data stream and the subset being associated with an amount of permissible delay for processing. The method may include delaying processing the subset of access requests based at least in part on the permissible delay and association with the data stream. The method may include processing the subset of access requests sequentially based at least in part on the delay.

In some implementations, a system comprises a controller of a non-volatile memory device. The controller may receive a set of access requests, with the set of access requests comprising a subset of the set of access requests that are associated with a data stream and the subset being associated with an amount of permissible delay for processing. The controller may delay processing the subset of access requests based at least in part on the permissible delay and association with the data stream. The controller may store the subset of access requests in a buffer. The controller may process the subset of access requests sequentially based at least in part on the delay.

In some implementations, a computer program product comprises one or more computer readable storage media and program instructions collectively stored on the one or more computer readable storage media. The program instructions comprise program instructions to receive a set of access requests, with the set of access request comprising a first subset of the set of access requests that are associated with a first data stream and a second subset of the set of access requests that are associated with a second data stream and the first subset being associated with an amount of permissible delay for processing. The program instructions comprise program instructions to delay processing the first subset of access requests based at least in part on the permissible delay and association with the first data stream. The program instructions comprise program instructions to process the second subset of access requests during the delay of processing of the first subset of access request. The program instructions comprise program instructions to process the first subset of access requests sequentially based at least in part on the delay.

### BRIEF DESCRIPTION OF THE DRAWINGS

FIG. 1 is a diagram of an example of coalescing of data at a storage device controller described herein.

FIGS. 2-3 are diagrams of example components of one or more devices of FIG. 1.

FIGS. 4-6 are flowcharts of example processes associated with coalescing of data at a storage device controller described herein.

### DETAILED DESCRIPTION

The following detailed description of example implementations refers to the accompanying drawings. The same reference numbers in different drawings may identify the same or similar elements.

In some examples, a link between a host and the storage device (e.g., compute ex press link (CXL), among other examples) may include unordered transactions (e.g., access requests). Memory transactions may be subject to fragmentation and complex CXL packing rules. A set of write commands from an application block may not arrive at the storage device (e.g., a CXL memory) in an original order. For example, multi-path fabrics may cause access requests (e.g., CXL requests or memory transaction, among other examples) to arrive out of order.

A controller of a storage device may have a small window for ordering access requests and may be blind to traffic patterns. For example, the controller has a limited view to see patterns of incoming access requests. The controller may have access to a content addressable memory (CAM), which is a special hardware queue allowing the controller to peek at all the contents and pull items out of order. However, the CAM has limited capacity and may be unable to predict traffic patterns that are larger than a queue of the CAM. Additionally, or alternatively, the CAM may push through incomplete pages of data without consideration of types of data, latency parameters of the data, or other factors.

Each time that the controller accesses (e.g., activates) a different physical location, such as a page, the storage device consumes power. Sequential accesses from multiple initiators (e.g., applications or hosts, among other examples) to the controller (e.g., a CXL expander) may result in random accesses at the memory. Random presentation of the input/output (I/O) results in wasted time on an associated bus as it moves between pages, and extra power spent in repeatedly activating the same pages. Additionally, tracking extra open pages ties up limited resources in the storage device (e.g., double data rate (DDR) memory) controller.

In some aspects described herein, not all memory operations (e.g., access requests) need to happen right away. For example, 4 kilobytes (KB) disk I/O or streaming video frames may not have tight latency requirements and may not impact performance with a delay. In some aspects, a host may provide information on a completion latency or time allowed for each application or initiator associated with a data stream.

In some aspects, the storage device may include a coalescing engine that identifies groups of related transactions and organizes the related transactions (e.g., related access requests) into, for example, page-sized batches. In some aspects, the storage device (e.g., the controller) may use timers to assist in submitting and completing each batch on time. For example, the timers may be associated with a default latency, a latency indicated in metadata of the access requests, or in other control information, among other examples. Based at least in part on grouping access requests into batches, the controller may improve a quantity of page open actions or a timing (e.g., latency) of page openings by collecting related access requests to the same page together and submitting them to the storage medium controller as a cohesive block of sequential accesses. Additionally, or alternatively, the storage device may reduce page churn, improve efficiency of utilization of memory bandwidth, support increased bus time for latency-sensitive operations, and write or read data once timer expires or a buffer has a full page of data, among other examples.

In some aspects, the storage device may apply an initiator identifier (ID) and permitted time per transaction (access request). In some aspects, the ID may be based at least in part on a heuristic value or a configuration, among other examples. For example, The ID may be associated with a host to device memory (HDM) address decoder index processing the access request or a process address space identifier (PASID) from a PCIe operation.

In some aspects, the storage device may be configured with one or more buffers having configurable windows of time allowed for the storage device to service each group of access requests. In some aspects, the window of time may be associated with a latency for the group of access requests. In some aspects, latency may be a specified time (metadata), a default time (default LLC time), based at least in part on a requesting path (e.g., how the data came to the memory), based at least in part on a load of the storage device, or based at least in part on a data-type of the streams associated with the access requests, among other examples. In some aspects, if the storage device is idle, timing for sending the access request may be closer to a deadline (e.g., a latency requirement). Alternatively, if the storage device is busy, the storage device may apply a relatively large buffer to the deadline.

In some aspects, the controller may store access requests in a buffer of the coalescing engine until the buffer has enough data associated with stored access requests to complete a page of storage in a storage medium. The controller may identify the access requests as having an acceptable delay based at least in part on an indication within metadata, based at least in part on one or more characteristics of the access request (e.g., type, timing, size, or requesting path, among other examples), or a default acceptable delay (e.g., applied to all access requests unless indicated otherwise), among other examples, In some examples, the buffer may be configured to be a size of a page (e.g., a DDR page). In some aspects, the coalescing engine may have a quantity of buffers that is configurable for different classes of traffic. When multiple access requests are stored in a buffer, the latency of the buffer and the stored access requests may be based at least in part on an earliest deadline timer (e.g., end of a window of acceptable delay) of any access request stored in the buffer. For example, deadline timers for access requests in a buffer may be based at least in part on an earliest deadline (e.g., expiration time) of the access requests (e.g., operations) stored in the buffer.

In some aspects, one or more access requests may not be stored in a buffer. For example, access requests (e.g., transactions) that are not indicated as being allowed for delay or marked with a deadline timer or latency window may proceed without delay to the controller for processing.

In some aspects, the storage device may flush sequential buffers to the controller for performing the access request. For example, the storage device (e.g., the coalescing engine) may flush a buffer for processing when a page buffer is full or when an expiration timer reaches a threshold. In some aspects, the threshold may be based at least in part on a load of the controller or storage device (e.g., when a controller has a heavy load, the controller may use a larger buffer from a deadline and when the controller has a light load, the controller may use a smaller buffer from the deadline). For example, the storage device may use a programmable expiration timer threshold that adapts to memory loading (e.g., using predictively latency). In some aspects, access requests (e.g., transactions) may be submitted to a higher priority queue, with a flag set to close a page immediately (e.g., triggering sending all access requests within the same buffer), or inserted into a primary stream of requests (e.g., sent to a buffer as described herein). In some aspects, the access requests may be submitted to the higher priority queue or the primary stream of requests based at least in part on an indicator in metadata of the access request or a parameter associated with the access request, among other examples.

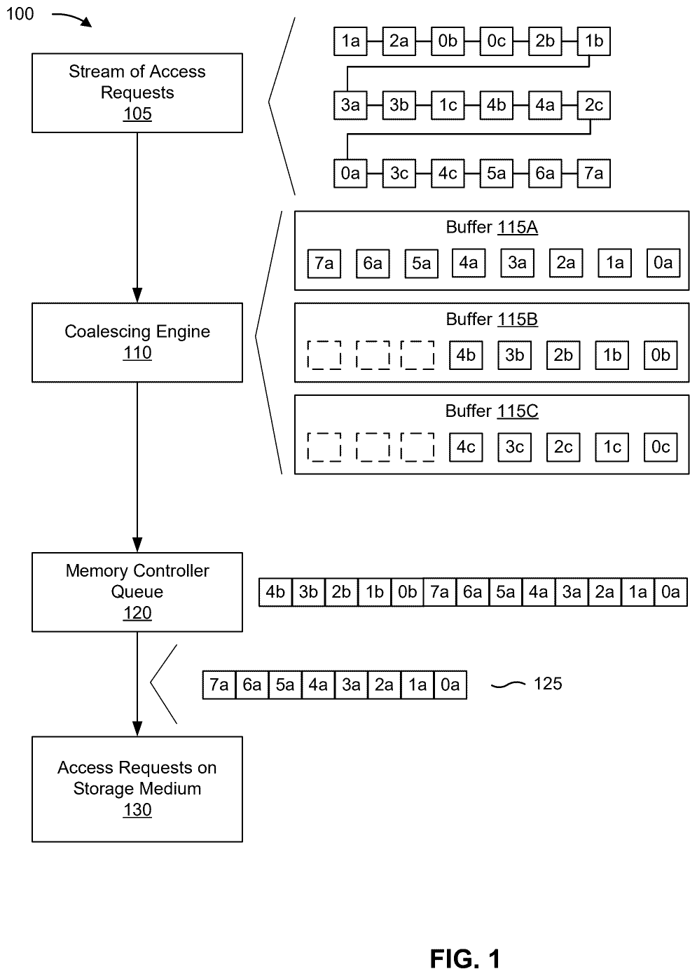

FIG. 1 is a diagram of an example 100 of coalescing of data at a storage device controller described herein. Operations shown in context of example 100 may be performed in association with reception of access requests. For example, the storage device may receive access requests from a host device, with the access requests being associated with one or both of read commands, write commands, or garbage collection, among other examples.

As shown in FIG. 1, the storage device may receive a stream 105 of access requests (e.g., a CXL memory request stream). In some aspects, the storage device may receive the stream 105 from multiple host or sources. For example, the storage device may receive a stream that like that shown in example 100, that includes a series of access requests associated with access stream a, access stream b, and access stream c. The storage device may receive the stream 105 with out-of-order access requests.

As shown in example 100, a coalescing engine 110 (e.g., within the storage device, such as in memory or a controller) may receive the stream 105 of out-of-order access requests and may sort or group the access requests into different buffers. The controller may identify the access requests as having an acceptable delay based at least in part on an indication within metadata, based at least in part on one or more characteristics of the access request (e.g., type, timing, size, or requesting path, among other examples), or a default acceptable delay (e.g., applied to all access requests unless indicated otherwise), among other examples, The coalescing engine 110 may sort the access requests in the order in which they were received. In some aspects, the access requests may be out of order within buffers 115A-115C.

In some examples, the coalescing engine 110 may place access requests 0a through 7a into buffer 115A, access requests 0b-4b into buffer 115B, and access requests 0c-4c into buffer 115C. The coalescing engine may identify the access requests as belonging to a group of access requests based at least in part on an indicator (e.g., within metadata) associated with the access requests or one or more characteristics of the access request (e.g., type, timing, size, or requesting path, among other examples). In some aspects, the group may be associated with a particular buffer. In some aspects, when a new group is identified for an access request (e.g., having no other access requests of the group within a buffer), the access request is assigned to an available buffer (e.g., any empty buffer).

In some aspects, other access requests may pass through the coalescing engine 110 without being delayed in a buffer, or may be routed around the coalescing engine 110 based at least in part on not being marked with a deadline timer or latency information for coalescing.

As shown in example 100, the coalescing engine 110 may send (e.g., flush) a buffer of access requests (e.g., access requests within the buffer) to a memory controller queue 120. For example, the coalescing engine 110 may send the buffer of access requests based at least in part on filling the buffer with access requests. In some aspects, the coalescing engine 110 may send the buffer of access requests based at least in part on a delay timer or latency of any access request stored in the buffer (e.g., indicating that the access request is to be performed soon to avoid failing a deadline or a latency parameter).

As shown in FIG. 1, the memory controller queue 120 may store a quantity of access requests received from the coalescing engine 110. In some aspects, the memory controller queue 120 may receive a full page of access requests from a single buffer, which may also be accompanied by one or more additional access requests. For example, as shown in FIG. 1, the memory controller queue 120 may store access requests 0a-7a from the buffer 115A and some access requests from the buffer 115B (e.g., access requests 0b-4b). The memory controller queue 120 may sort operations into order within an associated CAM window (e.g., access requests 0a-7a) before delivery to the storage medium. Remaining access requests in the memory controller queue 120 may remain in queue until more access requests are provided to the memory controller queue 120 from the coalescing engine 110. For example, the coalescing engine 110 may send additional access requests from the buffer 115B, if available (e.g., if received in the stream of access requests 105).

In some aspects, the access requests may be sorted within the memory controller queue 120 based at least in part on indicators within the access requests, one or more parameters of the access requests, or an order of indicated deadline timers of the access requests, among other examples. For example, the memory controller queue 120 may send an ordered set 125 of access requests to the controller for performing the access requests. The controller may perform the access requests on storage media 130 based at least in part on the access requests being ordered. For example, the controller may perform multiple consecutive access requests within a single page of the storage medium 130.

Based at least in part on grouping access requests into batches (e.g., in the buffers 115A-115C), the storage device may improve a quantity of page open actions or a timing (e.g., latency) of page openings. For example, the cohesive block of sequential accesses may reduce page churn, improve efficiency of utilization of memory bandwidth, support increased bus time for latency-sensitive operations, and write or read data once timer expires or a buffer has a full page of data, among other examples.

The number and arrangement of components shown in FIG. 1 are provided as an example.

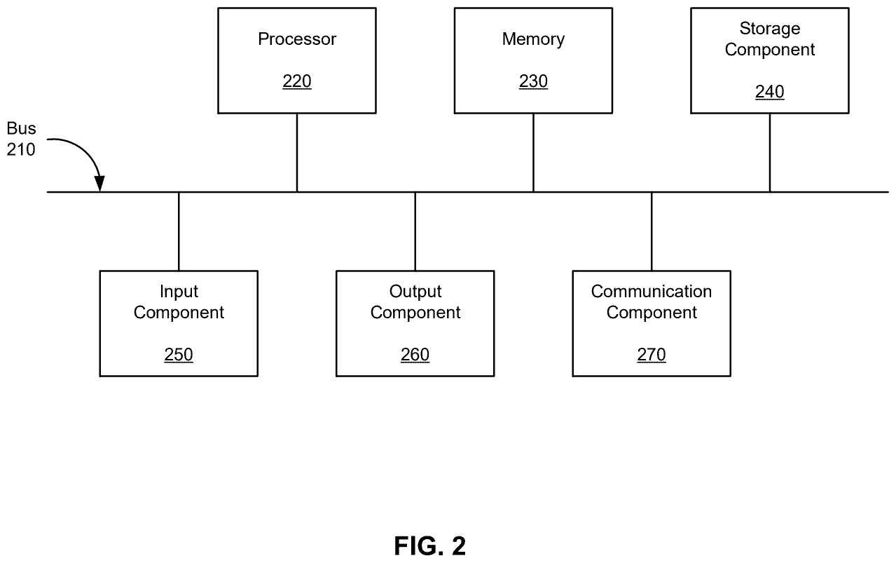

FIG. 2 is a diagram of example components of a device 200, which may correspond to one or more devices of FIG. 1, such as a controller or a host device. In some implementations, the controller or the host device may include one or more devices 200 and one or more components of device 200. As shown in FIG. 2, device 200 may include a bus 210, a processor 220, a memory 230, a storage component 240, an input component 250, an output component 260, and a communication component 270.

Bus 210 includes a component that enables wired or wireless communication among the components of device 200. Processor 220 includes a central processing unit, a graphics processing unit, a microprocessor, a controller, a microcontroller, a digital signal processor, a field-programmable gate array, an application-specific integrated circuit, or another type of processing component. Processor 220 is implemented in hardware, firmware, or a combination of hardware and software. In some implementations, processor 220 includes one or more processors capable of being programmed to perform a function. Memory 230 includes a random access memory, a read only memory, or another type of memory (e.g., a flash memory, a magnetic memory, or an optical memory).

Storage component 240 stores information or software related to the operation of device 200. For example, storage component 240 may include a hard disk drive, a magnetic disk drive, an optical disk drive, a solid state disk drive, a compact disc, a digital versatile disc, or another type of non-transitory computer-readable medium. Input component 250 enables device 200 to receive input, such as user input or sensed inputs. For example, input component 250 may include a touch screen, a keyboard, a keypad, a mouse, a button, a microphone, a switch, a sensor, a global positioning system component, an accelerometer, a gyroscope, or an actuator. Output component 260 enables device 200 to provide output, such as via a display, a speaker, or one or more light-emitting diodes. Communication component 270 enables device 200 to communicate with other devices, such as via a wired connection or a wireless connection. For example, communication component 270 may include a receiver, a transmitter, a transceiver, a modem, a network interface card, or an antenna.

Device 200 may perform one or more processes described herein. For example, a non-transitory computer-readable medium (e.g., memory 230 or storage component 240) may store a set of instructions (e.g., one or more instructions, code, software code, or program code) for execution by processor 220. Processor 220 may execute the set of instructions to perform one or more processes described herein. In some implementations, execution of the set of instructions, by one or more processors 220, causes the one or more processors 220 or the device 200 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 2 are provided as an example. Device 200 may include additional components, fewer components, different components, or differently arranged components than those shown in FIG. 2. Additionally, or alternatively, a set of components (e.g., one or more components) of device 200 may perform one or more functions described as being performed by another set of components of device 200.

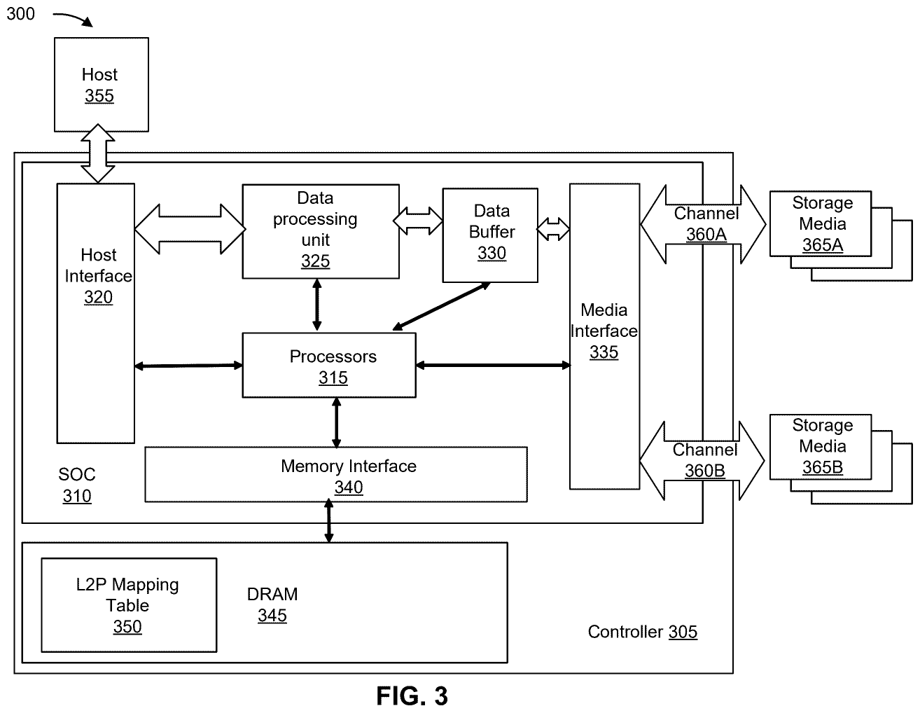

FIG. 3 is a diagram of example components of a storage device 300, which may correspond to one or more devices of FIGS. 1-2. In some implementations, the storage device 300 may include one or more devices 200 or one or more components of device 200. In some aspects, the device 200 may include one or more storage devices 300 or one or more components of storage device 300.

As shown in FIG. 3, the storage device 300 may include a controller 305 (e.g., an SSD controller). The controller 305 may include a system on chip (SOC) 310. The SOC 310 may perform computing or processing operations for the controller 305. The SOC may include one or more processors 315 that control, command, or observe operations at one or more other components of the SOC 310. The one or more processors 315 may be communicably coupled too one or more of a host interface 320, a data processing unit 325, a data buffer 330, a media interface 335, or a memory interface 340.

The host interface 320 may be configured to communicate with a host device (e.g., host device 355 described below). The DPU 325 may manage data flow between the host interface 320 and storage media. The DPU 325 may further include a functional block that is responsible for managing data operations, such as reading, writing, error correction, or formatting. The DPU 325 may perform tasks such as page and block management (e.g., organization of data within storage media), bad block management, garbage collection, error correction and detection (e.g., using error correction codes or soft bit processing), data transformation (e.g., address mapping from host addresses to physical addresses, compression and decompression, or scrambling, among other examples), encryption and decryption, or power management associated with data operations, among other examples.

The data buffer 330 is a pipeline data buffer for the data transition. The data buffer 330 may include a temporary storage area used to transfer or process data between the storage media and a host system. The memory interface 340 is an interface between controller 310 and external DDR or DRAM, which may be used to temporarily hold the data. The memory interface 340 may provide an interface between the SOC 310 and the DRAM 345 to facilitate transfers of information. For example, the memory interface 340 may support requests to access a logical to physical (L2P) mapping table to identify a physical location of data requested by the host device, or to provide mapping information for storage in the L2P mapping table.

The controller 305 may further include DRAM 345. The DRAM 345 may locally store information that is available on demand at the controller 305 for operations of the controller 305. For example, the DRAM 345 may store a logical-to-physical (L2P) mapping table 350 that maps logical locations of data and physical locations of data on connected storage media. In this way, the controller 305 may have access to mapping information for locating data on the connected storage media.

The host interface 320 may provide an interface for communicating with a host 355. For example, the host interface 320 may receive an access request or data for storage on connected storage media. In some aspects, the host interface 320 may provide data to the host after reading the data from the connected storage media.

The media interface 335 may communicate via one or more channels 360 (e.g., 360A and 360B) with one or more connected storage media 365 (e.g., 365A and 365B). For example, the controller 305 may perform or initiate a read or write operation at a physical location of a storage medium 365. In context of FIG. 1, the storage media 365 may include the storage medium described in connection with reference number 130 of FIG. 1.

The number and arrangement of components shown in FIG. 3 are provided as an example. For example, references to NAND are merely provided as examples. In practice, other non-volatile memory devices may be used in connection with storage device 300.

In some aspects, the coalescing engine 110, the buffers 115A-115C, or the memory controller queue 120 of FIG. 1 may be associated with the processors 315, the data buffer 330, or the media interface 335, among other examples. In an example, the buffers 115A-115C and the memory controller queue 120 may be associated with the data buffer 330 or the media interface 335, and the coalescing engine may be associated with the processors 315, and may issue instructions to the data buffer 330 or the media interface 335.

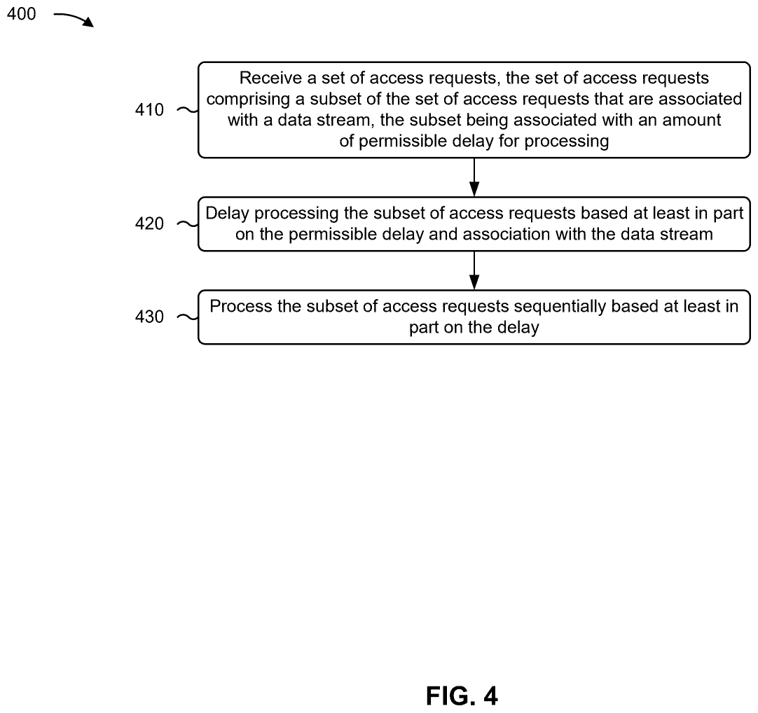

FIG. 4 is a flowchart of an example process 400 associated with coalescing of data at a storage device controller described herein. In some implementations, one or more process blocks of FIG. 4 may be performed by a storage device (e.g., a controller or storage media of the storage device). In some implementations, one or more process blocks of FIG. 4 may be performed by another device or a group of devices separate from or including the storage device, such as a controller. Additionally, or alternatively, one or more process blocks of FIG. 4 may be performed by one or more components of device 200, such as processor 220, memory 230, storage component 240, input component 250, output component 260, and/or communication component 270. Additionally, or alternatively, one or more process blocks of FIG. 4 may be performed by one or more components of storage device 300, such as SOC 310, processors 315, media interface 335, or DRAM 345, among other examples.

As shown in FIG. 4, process 400 may include receiving a set of access requests, the set of access requests comprising a subset of the set of access requests that are associated with a data stream, the subset being associated with an amount of permissible delay for processing (block 410). For example, the storage device may receive a set of access requests, the set of access requests comprising a subset of the set of access requests that are associated with a data stream, the subset being associated with an amount of permissible delay for processing, as described above. For example, FIG. 1 shows a stream of access requests 105 where a subset of access requests (e.g., 0a-7a) are associated with a data stream.

As further shown in FIG. 4, process 400 may include delaying processing the subset of access requests based at least in part on the permissible delay and association with the data stream (block 420). For example, the storage device may delay processing the subset of access requests based at least in part on the permissible delay and association with the data stream, as described above. For example, FIG. 1 shows storing subsets of access requests within buffers 115A-115C while waiting for a trigger to provide the access requests to the memory controller queue 120.

As further shown in FIG. 4, process 400 may include processing the subset of access requests sequentially based at least in part on the delay (block 430). For example, the storage device may process the subset of access requests sequentially based at least in part on the delay, as described above. For example, FIG. 1 shows sending a subset (e.g., 0a-7a) to a memory controller queue 120 and then to the storage medium after storage in the buffer. FIG. 1 also shows providing other access requests (e.g., 0b-4b) to the memory controller queue 120 that are not sent until after the first subset is sent.

Process 400 may include additional implementations, such as any single implementation or any combination of implementations described below and/or in connection with one or more other processes described elsewhere herein.

In a first implementation, delaying processing the subset of access requests comprises storing the subset of access requests in a buffer while later-received access requests are processed.

In a second implementation, alone or in combination with the first implementation, process 400 includes metadata of the access requests, one or more heuristic parameters, a host to device memory address, or indicating deadlines for processing the access requests of the subset.

In a third implementation, alone or in combination with one or more of the first and second implementations, the amount of permissible delay is based at least in part on one or more of a data type associated with the access request of the subset, an indication of the permissible delay in metadata of the access requests, or a source of the access requests.

In a fourth implementation, alone or in combination with one or more of the first through third implementations, the permissible delay is associated with an expiration time of an access request of the subset of access request.

In a fifth implementation, alone or in combination with one or more of the first through fourth implementations, processing the subset of access requests is based at least in part on one or more of a timer associated with at least one of the access requests of the subset of access requests, filling a buffer associated with the subset, or the buffer having a highest quantity of access requests relative to other buffers.

In a sixth implementation, alone or in combination with one or more of the first through fifth implementations, process 400 includes the additional subset not being associated with an expiration timer or an indication of permissible delay, or the additional subset not being associated with buffers of a coalescing engine of the storage device.

In a seventh implementation, alone or in combination with one or more of the first through sixth implementations, process 400 includes the additional subset being associated with an expiration timer or an indication of permissible delay, or the additional subset being associated with a buffer of a coalescing engine of the storage device.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

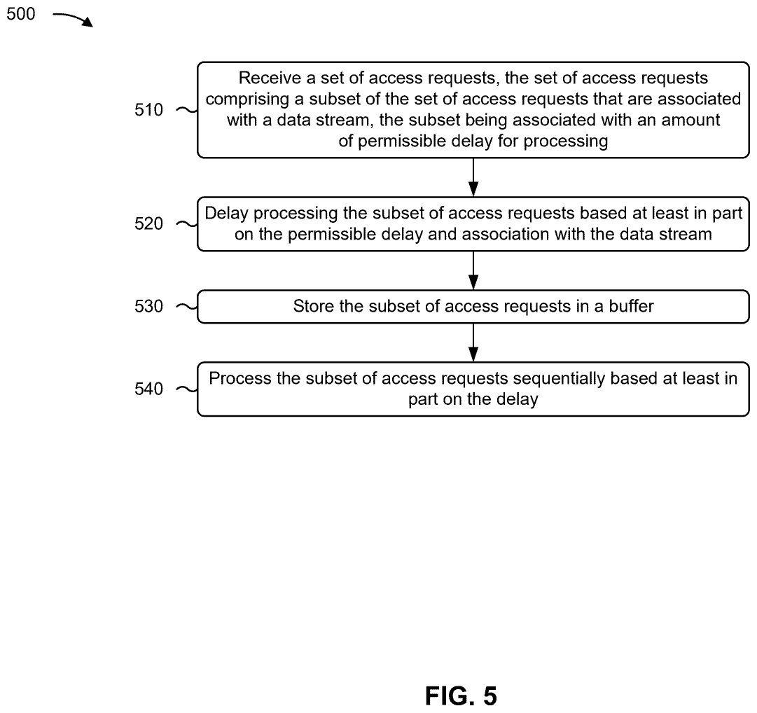

FIG. 5 is a flowchart of an example process 500 associated with coalescing of data at a storage device controller described herein. In some implementations, one or more process blocks of FIG. 5 may be performed by a storage device (e.g., a controller or storage media of the storage device). In some implementations, one or more process blocks of FIG. 5 may be performed by another device or a group of devices separate from or including the storage device, such as a controller. Additionally, or alternatively, one or more process blocks of FIG. 5 may be performed by one or more components of device 200, such as processor 220, memory 230, storage component 240, input component 250, output component 260, and/or communication component 270. Additionally, or alternatively, one or more process blocks of FIG. 5 may be performed by one or more components of storage device 300, such as SOC 310, processors 315, media interface 335, or DRAM 345, among other examples.

As shown in FIG. 5, process 500 may include receiving a set of access requests, the set of access requests comprising a subset of the set of access requests that are associated with a data stream, the subset being associated with an amount of permissible delay for processing (block 510). For example, the storage device may receive a set of access requests, the set of access requests comprising a subset of the set of access requests that are associated with a data stream, the subset being associated with an amount of permissible delay for processing, as described above. For example, FIG. 1 shows a stream of access requests 105 where a subset of access requests (e.g., 0a-7a) are associated with a data stream.

As further shown in FIG. 5, process 500 may include delaying processing the subset of access requests based at least in part on the permissible delay and association with the data stream (block 520). For example, the storage device may delay processing the subset of access requests based at least in part on the permissible delay and association with the data stream, as described above. For example, FIG. 1 shows storing subsets of access requests within buffers 115A-115C while waiting for a trigger to provide the access requests to the memory controller queue 120.

As further shown in FIG. 5, process 500 may include storing the subset of access requests in a buffer (block 530). For example, the storage device may store the subset of access requests in a buffer, as described above. For example, FIG. 1 storing subsets access requests within buffers 115A-115C while waiting for a trigger to provide the access requests to the memory controller queue 120.

As further shown in FIG. 5, process 500 may include processing the subset of access requests sequentially based at least in part on the delay (block 540). For example, the storage device may process the subset of access requests sequentially based at least in part on the delay, as described above. For example, FIG. 1 shows sending a subset (e.g., 0a-7a) to a memory controller queue 120 and then to the storage medium after storage in the buffer. FIG. 1 also shows providing other access requests (e.g., 0b-4b) to the memory controller queue 120 that are not sent until after the first subset is sent.

Process 500 may include additional implementations, such as any single implementation or any combination of implementations described below and/or in connection with one or more other processes described elsewhere herein.

In a first implementation, delaying of processing the subset of access requests comprises storing the subset of access requests in a buffer while later-received access requests, associated with a different data stream, are processed.

In a second implementation, alone or in combination with the first implementation, process 500 includes metadata of the access requests, one or more heuristic parameters, a host to device memory address, or indicating deadlines for processing the access requests of the subset.

In a third implementation, alone or in combination with one or more of the first and second implementations, the amount of permissible delay is based at least in part on one or more of a data type associated with the access request of the subset, an indication of the permissible delay in metadata of the access requests, or a source of the access requests.

In a fourth implementation, alone or in combination with one or more of the first through third implementations, processing of the subset of access requests is based at least in part on one or more of of a timer associated with at least one of the access requests of the subset of access requests, filling a buffer associated with the subset, or the buffer having a highest quantity of access requests relative to other buffers.

In a fifth implementation, alone or in combination with one or more of the first through fourth implementations, process 500 includes the additional subset not being associated with an expiration timer or an indication of permissible delay, or the additional subset not being associated with buffers of a coalescing engine of the storage device.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

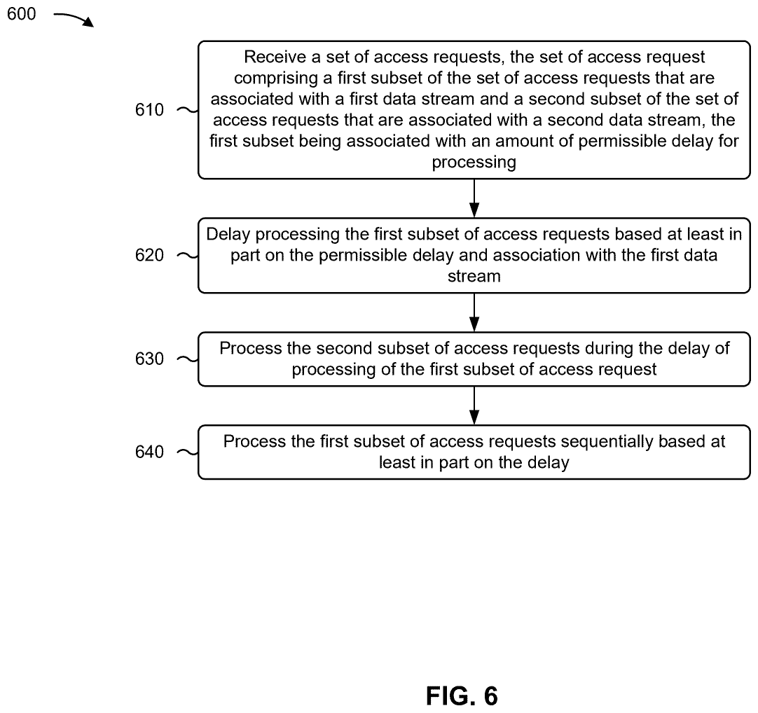

FIG. 6 is a flowchart of an example process 600 associated with coalescing of data at a storage device controller described herein. In some implementations, one or more process blocks of FIG. 6 may be performed by a storage device (e.g., a controller or storage media of the storage device). In some implementations, one or more process blocks of FIG. 6 may be performed by another device or a group of devices separate from or including the storage device, such as a controller. Additionally, or alternatively, one or more process blocks of FIG. 6 may be performed by one or more components of device 200, such as processor 220, memory 230, storage component 240, input component 250, output component 260, and/or communication component 270. Additionally, or alternatively, one or more process blocks of FIG. 6 may be performed by one or more components of storage device 300, such as SOC 310, processors 315, media interface 335, or DRAM 345, among other examples.

As shown in FIG. 6, process 600 may include receiving a set of access requests, the set of access request comprising a first subset of the set of access requests that are associated with a first data stream and a second subset of the set of access requests that are associated with a second data stream, the first subset being associated with an amount of permissible delay for processing (block 610). For example, the storage device may receive a set of access requests, the set of access request comprising a first subset of the set of access requests that are associated with a first data stream and a second subset of the set of access requests that are associated with a second data stream, the first subset being associated with an amount of permissible delay for processing, as described above. For example, FIG. 1 shows a stream of access requests 105 where a first subset of access requests (e.g., 0b-4b) are associated with a first data stream and a second subset of access requests (e.g., 0a-7a) are associated with a second data stream

As further shown in FIG. 6, process 600 may include delaying processing the first subset of access requests based at least in part on the permissible delay and association with the first data stream (block 620). For example, the storage device may delay processing the first subset of access requests based at least in part on the permissible delay and association with the first data stream, as described above. For example, FIG. 1 shows storing the first subset of access requests within buffer 115B and the second subset of access requests within buffer 115A while waiting for a trigger to provide the access requests to the memory controller queue 120.

As further shown in FIG. 6, process 600 may include processing the second subset of access requests during the delay of processing of the first subset of access request (block 630). For example, the storage device may process the second subset of access requests during the delay of processing of the first subset of access request, as described above. For example, FIG. 1 shows sending the second subset (e.g., 0a-7a) to a memory controller queue 120 and then to the storage medium after storage in the buffer. FIG. 1 also shows delaying the first set of access requests (e.g., 0b-4b) until after the second subset is sent to the memory controller queue 120.

As further shown in FIG. 6, process 600 may include processing the first subset of access requests sequentially based at least in part on the delay (block 640). For example, the storage device may process the first subset of access requests sequentially based at least in part on the delay, as described above. As shown in FIG. 1, the access requests of the second subset are ordered sequentially within the memory controller queue 120 so they are sent to the storage medium for sequential processing.

Process 600 may include additional implementations, such as any single implementation or any combination of implementations described below and/or in connection with one or more other processes described elsewhere herein.

In a first implementation, process 600 includes metadata of the first access requests and the second access requests, one or more heuristic parameters, a host to device memory address, or indicating deadlines for processing the first access requests or the second access requests.

In a second implementation, alone or in combination with the first implementation, the amount of permissible delay is based at least in part on one or more of a data type associated with the access request of the subset, an indication of the permissible delay in metadata of the access requests, or a source of the access requests.

In a third implementation, alone or in combination with one or more of the first and second implementations, the permissible delay is associated with an expiration time of an access request of the first subset of access request.

In a fourth implementation, alone or in combination with one or more of the first through third implementations, process 600 includes the second subset not being associated with an expiration timer or an indication of permissible delay, or the second subset not being associated with buffers of a coalescing engine of the storage device.

In a fifth implementation, alone or in combination with one or more of the first through fourth implementations, process 600 includes the third subset being associated with an expiration timer or an indication of permissible delay, or the third subset being associated with a buffer of a coalescing engine of the storage device.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

As used herein, the term “component” is intended to be broadly construed as hardware, firmware, or a combination of hardware and software. It will be apparent that systems or methods described herein may be implemented in different forms of hardware, firmware, or a combination of hardware and software. The actual control hardware or software code used to implement these systems or methods is not limiting of the implementations. Thus, the operation and behavior of the systems or methods are described herein without reference to specific software code-it being understood that software and hardware can be used to implement the systems or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims or disclosed in the specification, these combinations are not intended to limit the disclosure of various implementations. In fact, many of these features may be combined in ways not specifically recited in the claims or disclosed in the specification. Although each dependent claim listed below may directly depend on only one claim, the disclosure of various implementations includes each dependent claim in combination with other claims in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein is to be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “or,” unless explicitly stated otherwise (e.g., if used in combination with “either” or “only one of”).

What is claimed is:

1. A method performed by a storage device, the method comprising:
receiving a set of access requests, the set of access requests comprising a subset of the set of access requests that are associated with a data stream, the subset being associated with an amount of permissible delay for processing;
delaying processing the subset of access requests based at least in part on the permissible delay and association with the data stream; and
processing the subset of access requests sequentially based at least in part on the delay.

2. The method of claim 1, wherein delaying processing the subset of access requests comprises storing the subset of access requests in a buffer while later-received access requests are processed.

3. The method of claim 1, comprising identifying the subset as being associated with the data stream based at least in part on one or more of:
metadata of the access requests,
one or more heuristic parameters,
a host to device memory address, or
indicated deadlines for processing the access requests of the subset.

4. The method of claim 1, wherein the amount of permissible delay is based at least in part on one or more of:
a data type associated with the access request of the subset,
an indication of the permissible delay in metadata of the access requests, or
a source of the access requests.

5. The method of claim 1, wherein the permissible delay is associated with an expiration time of an access request of the subset of access request.

6. The method of claim 1, wherein processing the subset of access requests is based at least in part on one or more of:
expiration of a timer associated with at least one of the access requests of the subset of access requests,
filling a buffer associated with the subset, or
the buffer having a highest quantity of access requests relative to other buffers.

7. The method of claim 1, comprising processing an additional subset of access request based at least in part on one or more of:
the additional subset not being associated with an expiration timer or an indication of permissible delay, or
the additional subset not being associated with buffers of a coalescing engine of the storage device.

8. The method of claim 1, comprising delaying an additional subset of access request based at least in part on one or more of:
the additional subset being associated with an expiration timer or an indication of permissible delay, or
the additional subset being associated with a buffer of a coalescing engine of the storage device.

9. A system comprising:
a controller, of a non-volatile memory device, to:
receive a set of access requests, the set of access requests comprising a subset of the set of access requests that are associated with a data stream, the subset being associated with an amount of permissible delay for processing;
delay processing the subset of access requests based at least in part on the permissible delay and association with the data stream;
store the subset of access requests in a buffer; and
process the subset of access requests sequentially based at least in part on the delay.

10. The system of claim 9, wherein delaying of processing the subset of access requests comprises storing the subset of access requests in a buffer while later-received access requests, associated with a different data stream, are processed.

11. The system of claim 9, wherein the controller is to identify the subset as being associated with the data stream based at least in part on one or more of:
metadata of the access requests,
one or more heuristic parameters,
a host to device memory address, or
indicated deadlines for processing the access requests of the subset.

12. The system of claim 9, wherein the amount of permissible delay is based at least in part on one or more of:
a data type associated with the access request of the subset,
an indication of the permissible delay in metadata of the access requests, or
a source of the access requests.

13. The system of claim 9, wherein processing of the subset of access requests is based at least in part on one or more of:
expiration of a timer associated with at least one of the access requests of the subset of access requests,
filling a buffer associated with the subset, or
the buffer having a highest quantity of access requests relative to other buffers.

14. The system of claim 9, wherein the controller is to process an additional subset of access request, associated with a different data stream, based at least in part on one or more of:
the additional subset not being associated with an expiration timer or an indication of permissible delay, or
the additional subset not being associated with buffers of a coalescing engine of the storage device.

15. A computer program product comprising:
one or more computer readable storage media, and program instructions collectively stored on the one or more computer readable storage media, the program instructions comprising:
program instructions to receive a set of access requests, the set of access request comprising a first subset of the set of access requests that are associated with a first data stream and a second subset of the set of access requests that are associated with a second data stream, the first subset being associated with an amount of permissible delay for processing;
program instructions to delay processing the first subset of access requests based at least in part on the permissible delay and association with the first data stream;
program instructions to process the second subset of access requests during the delay of processing of the first subset of access request; and
program instructions to process the first subset of access requests sequentially based at least in part on the delay.

16. The computer program product of claim 15, wherein the program instructions comprise program instructions to identify the first subset as being associated with the first data stream and the second subset as being associated with the second data stream based at least in part on one or more of:
metadata of the first access requests and the second access requests,
one or more heuristic parameters,
a host to device memory address, or
indicated deadlines for processing the first access requests or the second access requests.

17. The computer program product of claim 15, wherein the amount of permissible delay is based at least in part on one or more of:
a data type associated with the access request of the subset,
an indication of the permissible delay in metadata of the access requests, or
a source of the access requests.

18. The computer program product of claim 15, wherein the permissible delay is associated with an expiration time of an access request of the first subset of access request.

19. The computer program product of claim 15, wherein the program instructions comprise program instructions to process the second subset of access requests during the delay based at least in part on one or more of:
the second subset not being associated with an expiration timer or an indication of permissible delay, or
the second subset not being associated with buffers of a coalescing engine of the storage device.

20. The computer program product of claim 15, wherein the program instructions comprise program instructions to delay processing of a third subset of access request based at least in part on one or more of:
the third subset being associated with an expiration timer or an indication of permissible delay, or
the third subset being associated with a buffer of a coalescing engine of the storage device.
